(19) United States
(12) Patent Application Publication
(10) Pub. No.: US 2025/0382756 A1
(43) Pub. Date: Dec. 18, 2025

(54) STRUCTURAL CABLE WITH PROTECTIVE SHIELD, AND CONSTRUCTION WORK COMPRISING SUCH A CABLE

(71) Applicant: SOLETANCHE FREYSSINET, Rueil Malmaison (FR)

(72) Inventors: Vincent MAILLET, Magny Les Hameaux (FR); Ronan SOLET, Cessonsevigne (FR); Matthieu GUESDON, Puteaux (FR); Miklos TOTH, Les Lilas (FR)

(73) Assignee: SOLETANCHE FREYSSINET, Rueil Malmaison (FR)

(21) Appl. No.: 18/877,784

(22) PCT Filed: Jun. 20, 2023
(86) PCT No.: PCT/FR2023/050918

§ 371 Date: Dec. 20, 2024

(30) Foreign Application Priority Data
Jun. 21, 2022 (FR) FR2206119

(51) Int. Cl. E01D 19/16

(52) U.S. Cl. CPC E01D 19/16

(57) ABSTRACT

A protective shield includes two protective elements extending in parallel with the tensioning member and a system for assembling the protective elements around an axial passage for the tensioning member. Each protective element has a first shell adjacent to the axial passage, a second shell, and a filling in a radial gap between the first and second shells. The protective elements have between them two interface zones, diametrically opposed with respect to the axial passage. The assembly system of the protective elements is configured to apply a force that presses the protective elements against each other in the two interface zones.

The present invention concerns techniques for protecting tensioning members used in construction.

The tensioning members to be protected over all or part of their length may in particular be suspension cables (or wire stay rope cables) of a structure or staying cables of a tall structure.

### BACKGROUND

The cables used in civil engineering structures may be exposed to threats or to vandalism, in particular close to their bottom anchorages at the level of the deck of a bridge, for example. The threats may be:
from explosive elements,
from mechanical cutting elements,
from oxycutting elements,
from fire, etc.

To protect against the above threats, devices are used that are generally in the form of cylindrical shields enveloping the cable in the area exposed to the threats.

The shields often consist of shells offering an appropriate ductility, able to resist an

impact and able to be deformed to dissipate a significant part of the energy involved in the threat. Examples of shields of this type are described in the documents WO 2004/048832 A1, U.S. Pat. No. 8,769,882 B2, WO 2020/249193 A1 and US 2021/0207332 A1.

These protective shields may be divided into longitudinal cylindrical segments (typically 1 to 3 meters long). A segment may consist of a single cylindrical shell if the protection is installed before the cable. It may also consist of a plurality of shells in the form of cylindrical sectors that are assembled to envelop the cable when the protection is installed after the cable itself or if it is to be removable for maintenance, inspection or replacement.

In the situation where the shield includes a plurality of shells in the form of cylindrical sectors the junction of those shells constitutes a weak point in the protection and necessitates special provisions to offer sufficient resistance to threats.

There exists a need to improve the strength and/or the durability and/or the conditions for fabrication, mounting and even demounting of the protective shield disposed around the cable.

### SUMMARY

To protect a tensioning member there is proposed a shield comprising two protective elements extending parallel to the tensioning member and a system for assembling the protective elements around an axial passage for the tensioning member. Each protective element includes a first shell adjacent to the axial passage, a second shell and a filling in a radial gap between the first shell and the second shell. The system for assembling the protective elements is configured to exert a clamping force on the protective elements urging one toward the other in two interface zones between the protective elements.

In some embodiments the radial gap between the shells of a protective element is maintained by rods engaged radially through the first shell from the axial passage and bearing against an internal face of the second shell.

In some embodiments the second shell of a protective element is fixed to the first shell by connecting members engaged through the first shell from the axial passage.

In some embodiments the two interface zones between the protective elements are diametrally opposite relative to the axial passage. The two protective elements may in particular have the same geometric shape.

In some embodiments a water drainage channel is formed in the interface zone between the two protective elements.

In each interface zone between the two protective elements one of the two protective elements may have at least one convex shape and the other of the two protective elements may have at least one concave shape conjugate with the convex shape. The respective convex and concave shapes of the two protective elements may extend over all the length of the protective elements. They can also be used to form a water drainage channel at the bottom of the concave shape in the interface zone between the two protective elements.

In some embodiments separation lines between the respective first shells of the two protective elements extend parallel to the axial passage and feature an angular offset relative to the two interface zones between the elements.

In some embodiments the system for assembling the protective elements comprises a bayonet coupling formed between the first shells of the two protective elements. This bayonet coupling includes a ramp inclined relative to the axial direction and cooperating with a locking member to exert the clamping force urging the protective elements toward one another. To assemble the protective elements the bayonet coupling may allow axial sliding between the first shells of the two protective elements. The locking member may comprise a slider disposed at the level of the axial passage and able to be moved parallel to the axial passage, with on the slider a locking pin cooperating with the inclined ramp of the bayonet coupling.

In some embodiments the system for assembling the protective elements comprises male parts and female parts provided in the protective elements at the level of the interface zones between them and the locking members. The male parts penetrate into the female parts to position mutually the two protective elements. The locking members cooperate with at least some of the male parts to exert the clamping force urging the protective elements toward one another.

In particular each locking member may have an inclined surface to interact with a shoulder formed on a male part of the system for assembling the protective elements. In some embodiments the locking members are controllable from the axial ends of the protective elements. To this end one possibility is for each locking member to be pushed from an axial end of a protective element into a respective housing to cooperate with a male part of the system for assembling the protective elements.

The male parts of the assembly system may also comprise positioning pins distributed along the protective elements.

In some embodiments the system for assembling the protective elements is formed on protuberances on the first shells protruding toward the interior of the axial passage.

Some embodiments of the protective shield comprise a plurality of successive segments along the tensioning member, each segment being produced by assembling two protective elements. Two successive segments have between them an interface where respective end faces of the protective elements of the two segments bear on one another. The end faces of the protective elements at the interface between the successive segments may be provided with reliefs configured to prevent relative rotation of the segments about the axial passage.

At the interface between a first segment and a second segment the first shells of the protective elements of the first segment extend beyond the axial ends of the second shells of the protective elements of the first segment, parallel to the axial passage, whereas the first shells of the protective elements of the second segment are set back from the axial ends of the second shells of the protective elements of the second segment, parallel to the axial passage and the axial ends of the first shells of the protective elements of the first segment penetrate to the interior of the second shells of the protective elements of the second segment.

Between the successive segments there may be a gap parallel to the axial passage between the first shells of the protective elements.

Another possibility of interest is that the interface zones between the two protective elements of a first segment are angularly offset relative to the interface zones between the two protective elements of a second segment adjacent to the first segment.

In some embodiments of the protective shield the filling in the radial gap between the first and second shells of each protective element comprises a cement material and at least one metal band in the cement material. The metal band may be disposed substantially parallel to the first and second shells. It may extend over a majority of the length of the shells from one interface zone to the other. The metal band may have a perforated structure.

The filling in the radial gap between the shells of each protective element may further comprise an auxetic material.

Another aspect described in the present document relates to a structural cable comprising a tensioning member and a protective shield as indicated hereinabove disposed around the tensioning member. The present document further concerns a construction work comprising such a structural cable the tensioning member of which is tensioned and anchored at two ends. The construction work is for example a stayed structure.

In some embodiments the system for assembling the protective elements comprises fishplates at the level of the end faces of a segment to maintain the clamping force urging the protective elements toward one another.

The structural cable may comprise an intumescent first longitudinal seal in at least one interface zone between the protective elements.

The structural cable may comprise a second longitudinal seal in at least one interface zone between the protective elements, the second seal being made of elastomer and configured to be compressed during assembly of the protective elements toward one another.

### BRIEF DESCRIPTION OF THE DRAWINGS

Other particular features and advantages of the present invention will become apparent in the following non-limiting description of one embodiment given with reference to the appended drawings in which:

FIG. 1 shows highly schematically a cross section of a tensioning member protected by a shield according to the invention,

FIGS. 2 and 3 are perspective views of a first embodiment of the shield with a portion cut away in FIG. 2,

FIG. 4 is another perspective view in cross section of the first embodiment of the shield,

FIG. 5 is an exploded perspective view depicting a steel component that is part of the first embodiment of the shield,

FIGS. 6 to 9 are perspective views depicting a part of a system for assembling shells in the first embodiment of the shield,

FIG. 10 shows highly schematically an interface zone between two protective elements of one example of a shield according to the invention,

FIG. 11 is a perspective view of a second embodiment of the shield,

FIGS. 12 to 14 are partial views depicting a part of a system for assembling shells in a third embodiment of the shield,

FIG. 15 is a perspective view of internal shells of a shield according to a fourth embodiment,

FIG. 16 is a perspective view depicting a part of a system for assembling shells in the fourth embodiment of the shield,

FIGS. 17 and 18 are perspective views of components of the assembly system in the fourth embodiment,

FIG. 19 is a schematic view in cross section of another embodiment of a shield according to the invention,

FIGS. 20 to 22 are perspective views depicting a protective element according to a fifth embodiment of the shield with a transparent part in FIG. 22,

FIG. 23 is a perspective view depicting an assembly of two segments of a protective shield one of which segments is represented partially with only one protective element, and

FIG. 24 is a schematic view depicting a locking system of the fifth embodiment in longitudinal section.

### DESCRIPTION OF EMBODIMENTS

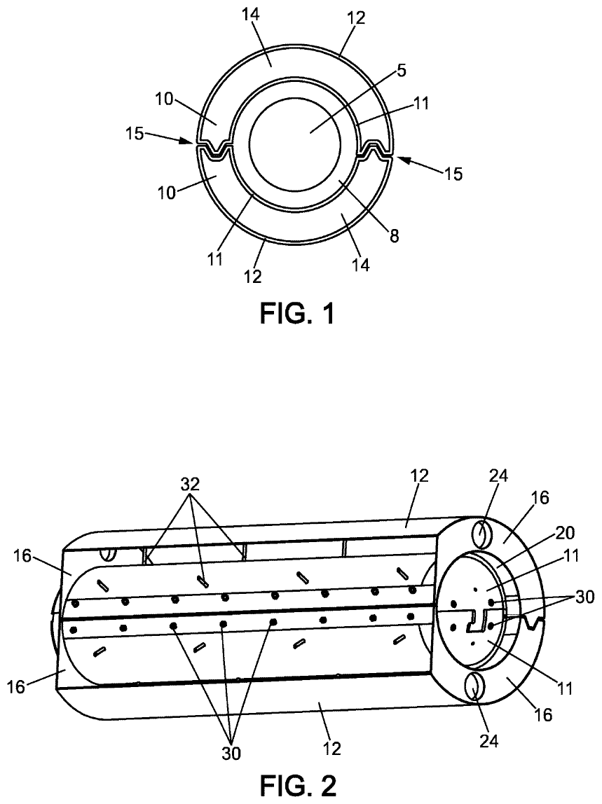

FIG. 1 depicts a tensioning member 5 protected by a shield consisting of two protective elements 10 assembled around it.

In the remainder of the present description, without this being limiting on the invention, there is considered a tensioning member 5 consisting of a bridge wire stay rope. Such wire stay ropes may be exposed to various threats, in particular near the deck of the bridge. This is why it is usual to surround them with a protective envelope over a part of their length, for example to a height of 2 to 5 meters above the deck.

The wire stay rope 5 represented schematically in FIG. 1 includes a group of parallel armatures tensioned between their ends, for example one end situated on the deck of the bridge and the other end situated on a pylon from which the deck is suspended. At its two ends anchor devices maintain the tension in the armatures of the wire stay rope. The armatures may consist of metal strands and may be surrounded by individual sheaths made of plastic material to protect them against corrosion. Another plastic material sheath contains collectively the group of armatures and confers on the wire stay rope a smooth appearance over its length. In the example considered here this assembly constitutes the tensioning member 5 that is to be protected by the shield against diverse threats such as explosion, fire or mechanical aggression.

Each protection element 10 includes an interior shell 11 and an exterior shell 12 both made of a rigid material, for example of steel. In the example represented the two shells 11, 12 of each protective element 10 are of semicylindrical shape with radii greater than that of the wire stay rope 5. The interior shells 11 of the two protective elements 10 together form an interior wall of the shield that defines an axial passage 8 for the wire stay rope 5. The exterior shells 12 of the two protective elements 10 together form an exterior wall exposed to the environment of the wire stay rope and thus to any threat.

The radial gap between the two shells 11, 12 of a protective element 10 is occupied by a filling 14 having a high resistance to compression forces.

The filling 14 may be based on a cement material poured into the volume defined by the shells 11, 12. An auxetic material having a negative Poisson's coefficient may equally be used for the filling 14 to offer increased resistance in the event of an explosion near the shield.

The two protective elements 10 of the shield bear on one another in interface zones 15 which in the example represented are diametrically opposite with respect to the axial passage 8. In these interface zones 15 the protective elements 10 have conjugate shapes to facilitate assembling them and to offer a resistance to the penetration of a shockwave or forcing a tool into the interface 15.

To produce these conjugate shapes one of the two protective elements has a convex shape in the interface zone 15 and the other protective element has a complementary concave shape therein. These two complementary shapes engage one in the other when assembling the shield. They can extend over the entire length of the protective elements 10 to participate without interruption in the strength of the shield.

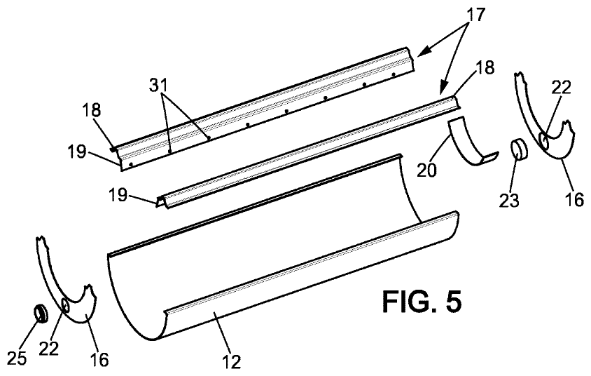

Referring to FIGS. 2 to 4, in a first embodiment two steel components are used to construct each protective element 10. A first steel component corresponds to the semicylindrical internal shell 11. The second steel component, represented in an exploded view in FIG. 5, includes the semicylindrical external shell 12, two axial end faces 16 that will be disposed perpendicularly to the direction of the wire stay rope 5 and two profiled members 17 that are connected to the external shell 12 in the interface zones 15. Each profiled member 17 has a portion 18 with the aforementioned convex or concave shape that will be placed in an interface zone 15 and a portion 19 bent inwards to be connected to the internal shell 11. At one of the ends of the second steel component represented in FIG. 5 another plate 20 of circular arc shape with a radius corresponding to that of the internal wall 11 and to the smallest radius of the axial end face 16 is provided to close the volume defined by the two shells 11, 12.

As seen in FIG. 5 a hole 22 may exist in each axial end face 16 of the second steel component. At one of the axial ends the hole 22 is blocked by a plug 23 shaped to leave a recess 24 on the exterior side of the end face 16. At its other axial end the hole 22 is not blocked but an annular ring 25 is connected to it to produce a projecting shape on the exterior side of the end face 16 so as to be able to cooperate with a recess similar to the recess 24 formed on an adjacent protection element 10.

The various parts represented in FIG. 5 are welded to one another to produce the second steel component. The latter is then joined to the first steel component that forms the semicylindrical internal shell 11 of the protective element 10. To fix together the two steel components screws 30 are engaged in holes formed in the internal shell 11 and come to engage with threads provided in the bent portions 19 of the profiled members 17. Alternatively the screws 30 may be replaced by other connecting members engaged through the first shell 11 from the axial passage 8, such as rivets for example.

Before fixing together the two steel components it is judicious to dispose between the two shells 11, 12 spacing elements in the form of rods 32. These rods 32 are introduced from the axial passage 8 side through threaded holes 33 formed for this purpose in the internal shell 11, which will make it possible to preserve a smooth appearance of the outside of the shield. The rods 32 are threaded and engaged radially in the holes 33 until they come to abut on the external shell 12. They will participate in increasing the cohesion and the robustness of the shield in the event of an explosion near the wire stay rope.

Once the two steel components have been fixed together and provided with the spacing rods 32 the protective element is filled with the cement material poured into the radial gap between the shells 11, 12. The cement material is introduced via the hole 22 that has remained open at one of the axial ends of the protective element until it reaches the level of the end face 16 and of the ring 25 bordering this hole 22.

The fabrication of the protective element 10 is finished after the cement material has cured. A pair of protective elements 10 may then be assembled around the wire stay rope 5.

In the embodiment depicted in FIGS. 2-9 an assembly system for the two protective elements 10 comprises bayonet couplings formed between their inner shells 11.

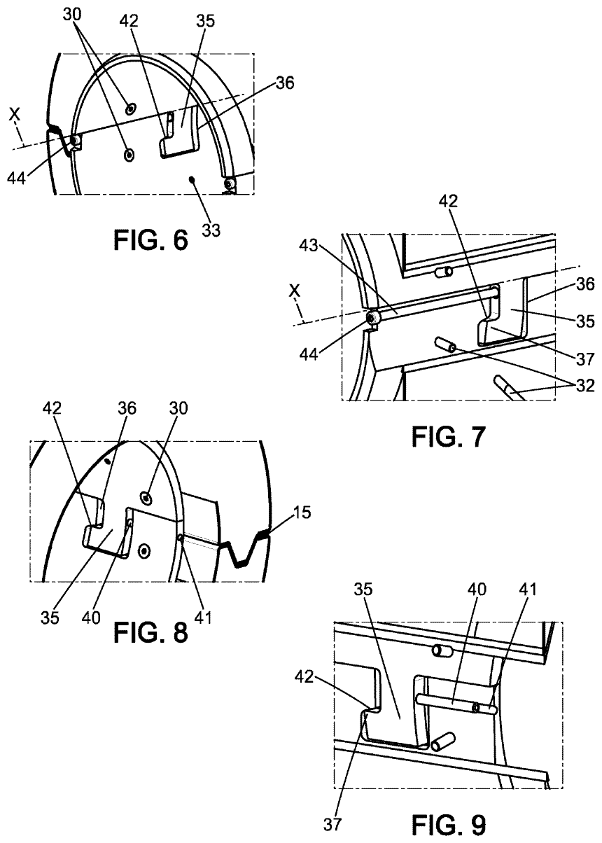

As FIGS. 6-9 show more precisely the internal shell 11 of one of the protection elements 10 has along its line of separation X from the internal shell 11 of the other protective element 10 a series of generally L-shaped hooks 35 and the other protective element 10 has a corresponding series of L-shaped indentations 36. The indentations 36 have a height perpendicular to the separation line X less than the height of the bent portion 19 of the profiled members 17 represented in FIG. 5 so that they do not cause any leakage of the cement material of the filling 14 when that material is poured. The indentations 36 are each sufficiently wide parallel to the separation line X to receive a hook 35 when the protective elements 10 are moved closer to one another. Once the two protective elements 10 are in abutment in the interface zones 15 in which the convex and concave shape interpenetrate the L-shaped hook 35 is inscribed in the L-shape of an indentation 36.

The installer can mutually lock the two protective elements 10, for example by maneuvering screws 40 engaged in threaded holes 41 formed in the longitudinal direction in the thickness of the internal shell 11 featuring the indentation 36. The hole 41 extends between one of the axial ends of this internal shell 11 (the end visible in FIGS. 8-9) and the indentation 36 closest to that axial end. By maneuvering the screw 40 the installer bears on the hook 35 received in this indentation, which causes relative longitudinal movement of the two protection elements 11. The hooks 35 are then prevented from escaping from the indentations 36 if an attempt is made to move the protective elements 10 away from one another.

Seen in FIGS. 6-9 is an inclined ramp 42 between the base of the L-shape of the indentations 36 and the base of the L-shape of the hooks 35 received in the indentations 36. The configuration of this inclined ramp 42 is such that the thrust exerted by means of the screws 41 when assembling the protective elements 10 is reflected in a force that clamps them one against the other. This enables an increase in the robustness of the shield with respect to shockwaves or other threats. In the example represented the inclined ramp 42 is formed at the edge of the indentation 36 and cooperates with the edge 37 of the L-shape of the hook 35 that forms a locking member. The configuration could also be reversed: an inclined ramp in the base of the L-shape of the hook 35 and a locking member at the corner of the L-shape of the indentation 36.

If it is necessary to remove the shield, that remains possible by maneuvering the screw in the opposite direction. To assist dislodging the hooks 35 from the indentations 36 other threaded holes 43 and other screws 44 may be provided at the axial end of the internal shell 11 (as seen in FIGS. 6-7) situated opposite that where the holes 41 and the screws 40 are located. The hole 43 extends between the axial end of the internal shell 11 and the indentation 36 nearest that axial end. As seen in FIGS. 8-9, after releasing the screws 41 the operative can drive the screws 44 into the holes 43, which causes relative longitudinal movement of the two protective elements 10 that releases the force that was pressing them one against the other. The operative can then retract the screws 44 and separate the two protective elements 10. Alternatively, the screws 44 are replaced by simple rods and the shield is unlocked by hammering these rods.

Also seen in FIGS. 2-4 and 6-9 is that an angular offset exists around the direction of the axial passage 8 between the separation lines X of the two internal shells 11 and the interface zone 15 between the protective elements 10. This angular offset contributes to opposing the progress of any shockwave toward the interior of the axial passage 8 that contains the wire stay rope 5 in addition to the interpenetration of the convex and concave shapes in the interface zones 15.

FIGS. 2-9 show two protective elements 10 assembled to form a shield segment according to the first embodiment. Such a segment may have a length from one meter to a few meters. If the wire stay rope 5 has to be protected over a greater length, a plurality of segments of this type may be placed end-to-end.

The shield then consists of a plurality of successive segments along the wire stay rope 5. Each segment is produced by assembling two protective elements 10, for example of the type described above.

The interface between two successive segments is located at the level of the end faces 16 of their protective elements 10. The projecting shape produced by a ring 25 on the end face 16 of a protective element 10 is inserted in the recess 24 on the end face 16 of the adjacent protective element, which prevents relative movement in rotation of the two successive segments around the axial passage 8.

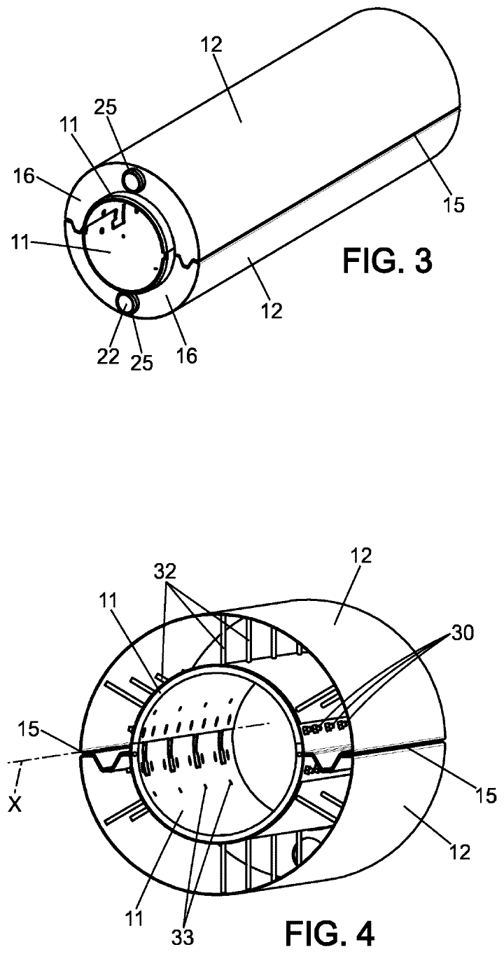

At one axial end of each segment of the embodiment from FIGS. 2 to 9 (the end that can be seen in FIGS. 3, 6 and 7) the internal shells 11 extend beyond the axial ends of the external shells 12 and the end faces 16 of the protective elements 10 of the segment parallel to the passage 8. Conversely, at the other end of the segment (that visible in FIGS. 2, 8 and 9, where the circular arc plates 20 of the steel components described above with reference to FIG. 5 are found) the internal shells 11 are set back from the axial ends of the external shells 12 and the end faces 16 of the protective elements 10.

Thus on end-to-end assembly of the two shield segments the interior wall that the internal shells 11 of one of the segments form is inserted over a certain length inside the other segment. This also contributes to presenting an obstacle to the penetration of any shockwave from the exterior to the axial passage 8 at the interface between the segments.

The projection of the internal shells 11 at one end of the segment may be over a length shorter than that of the setback present at the other end. This produces in parallel with the axial passage 8 a gap between the internal shells 11 of the adjacent segments and ensures that the two segments are in intimate contact with one another at the level of the end faces 16.

When two successive segments of the shield are joined, one possibility is to cause them to pivot relative to one another about the axial passage 8 in order for the interface zones 15 between their protective elements 10 to be angularly offset from one segment to the other. This contributes to reinforcing the cohesion of the shield.

Although this is not represented in FIGS. 3-5 it is convenient for the two protective elements 10 forming a shield segment to have the same geometrical shape and to be stackable. In particular each element 10 has, as in FIG. 1, a convex shape in one of its interface zones 15 and a concave shape in the other of its interface zones 15. Likewise, the bayonet couplings between the internal shells can be configured in a symmetrical manner. Thus it is possible to provide a single fabrication process for all of the protective elements 10 that will be used to constitute the shield protecting a wire stay rope, enabling the cost of the shield to be reduced.

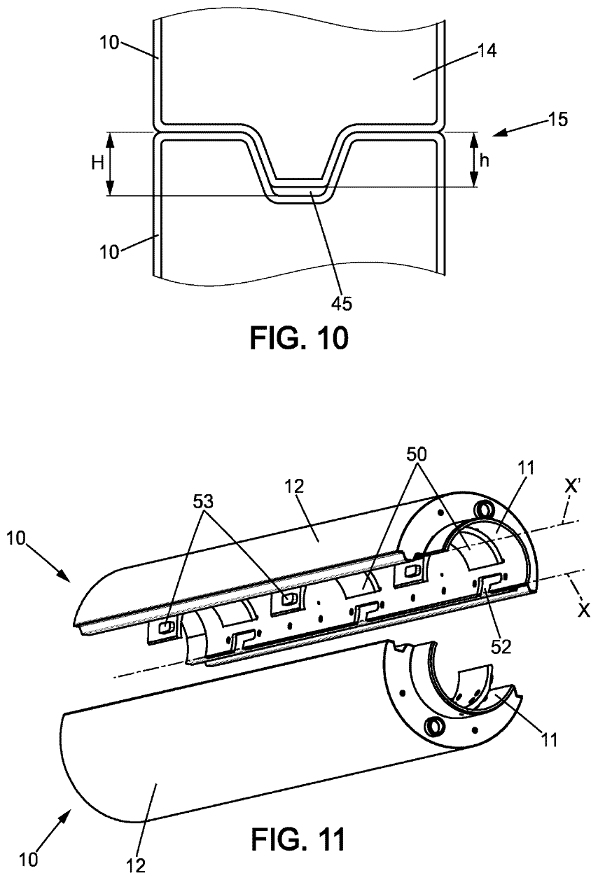

As represented schematically in FIG. 10 the interface zones 15 between the two protective elements 10 forming a shield segment can be arranged to have a water drainage channel 45 in the longitudinal direction.

In the FIG. 10 example the conjugate convex and concave shapes, which extend over all the length of the elements 10, are of trapezoidal cross section, the convex shape having a height h less than the depth H of the concave shape. Thus the contact between the two protective elements 10 where the clamping force generated by their assembly system is exerted is formed on the flanks of the conjugate convex and concave shapes and outside them while a drainage channel 45 of height H-h remains at the bottom of the concave shape. If water infiltrates between two protective elements 10 it could be evacuated via the

channel 45 toward the bottom of the wire stay rope, where the channel 45 is open. The drainage channel 45 prevents trapping of water between the elements 10 so that cycles of freezing and thawing will not damage the shield and will not interfere with the clamping force between the elements 10.

Referring to FIG. 11, the second embodiment of the shield is somewhat similar to the first embodiment depicted in FIGS. 2-9. It also includes a bayonet coupling that allows axial sliding between the internal shells 11 for assembling the protective elements 10.

The two protective elements 10 of a segment represented in FIG. 11 have the same geometric shape. Their steel components including the external shell 12 are identical to those of the first embodiment. Their other steel components including the internal shells 11 differ therefrom in the type of bayonet coupling employed. These steel components comprise for each element 10 protuberances 50 mounted so as to constitute an overthickness on the interior face of the internal shell 11 and L-profile notches 52 formed in the thickness of the internal shell 11 at the end of a separation line X from the other internal shell. In line with a notch 52 each protuberance 50 extends in the circumferential direction of the internal shell 11 over one half-turn from the position of this notch 52 so as to leave it exposed. The protuberance 50 extends beyond the opposite separation line X′ and the protruding part has on its exterior face a positioning pin 53 adapted to cooperate with a notch 52 of the twinned protective element 10.

The two protective elements 10 of the second embodiment of the shield are fabricated by a method analogous to that described above. To assemble them together they are moved closer on either side of the wire stay rope 5 and the pins 53 of one element 10 are engaged in the notches 52 of the other element 10 and vice versa. Once the two protective elements 10 are in contact they are moved longitudinally to lock them together. An inclined ramp (which is not very clearly visible in FIG. 11) exists at the interface between a pin 53 and a notch 52 in such a manner as to exert the clamping force on the protection elements 10 during assembly thereof. The overthickness protuberances 50 assist in centering the shield relative to the wire stay rope 5 that it protects.

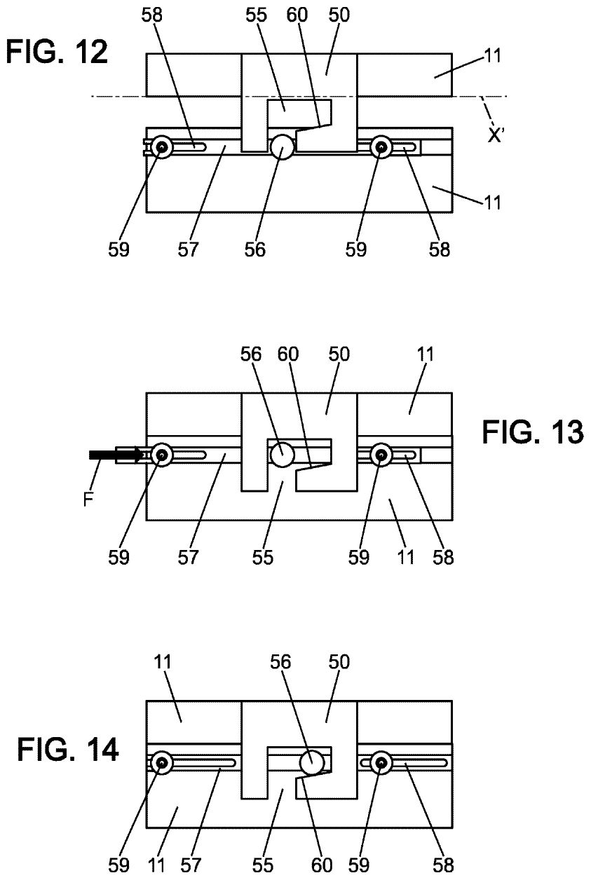

A third embodiment of a shield segment represented schematically in FIGS. 12-14 also has on each internal shell 11 overthickness protuberances 50 a part of which projects beyond the separation line X′. This time it is the protruding part of the protuberance 50 that includes the L-shape notch 55 of the bayonet coupling. This notch 55 cooperates with a locking pin 56 carried by a slider 57 mounted on the interior face of the internal shell 11 of the twinned protective element.

The slider 57 is of elongate shape and includes longitudinal slots 58. Supports 59 are connected to the internal shell 11 of the twinned protective element, for example by screwing them to it, and are received in the slots 58 of the slider 57. The slider 57 can be actuated from one of the axial ends of the shield segment to move it parallel to the axial passage 8.

When the two protective elements 10 are offered up on either side of the wire stay rope 5 in order to be assembled the sliders 57 disposed near their interface zones 15 are positioned so that the pins 56 are inserted in the L-shaped notches 55 (FIG. 12). Once the two elements 10 are in contact the slider 57 is moved as indicated by the arrow F in FIG. 13, which locks the two protective elements 10. In this case locking is not accompanied by relative axial sliding of the two protective elements 10.

FIGS. 12-14 show an inclined ramp 60 formed at the level of each notch 55. The inclination of the ramp 60 is such that the pin 56 pushed by the movement of the slider 57 when assembling the shield segment exerts the clamping force on the protection elements by acting on the ramp 60. To prevent untimely unlocking in the locked position depicted in FIG. 14 a system for immobilizing the slider 57 may be used at the end where it is 10 actuated.

If it is necessary to remove the shield the locking system is deactivated, the slider 57 is actuated in the opposite direction, and the two protective elements 10 can be moved away from one another.

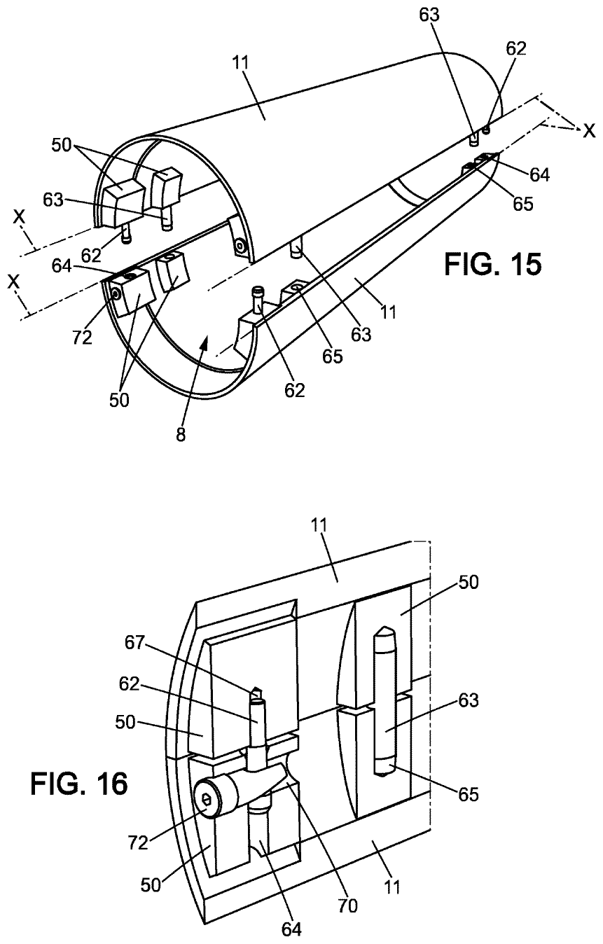

FIG. 15 shows an arrangement of the internal shells 11 in a fourth embodiment of the protective shield. The external shells 12 and the filling 14 of the protective elements 10 can in this fourth embodiment be similar to those described above. FIG. 16 is a partial view showing components of the protective element assembly system once they have been assembled.

In this embodiment the system for assembling the protective elements 10 is again formed on protuberances 50 on the internal shells 11 extending toward the interior of the axial passage 8. In this case the protuberances 50 are located near the separation lines X between the internal shells 11. They nevertheless contribute to centering the wire stay rope 5 in the shield.

The system for assembling the protective elements 10 of the fourth embodiment comprises male parts 62, 63 and female parts 64, 65 provided in the interface zones 15 between the protective elements 10. The female parts 64, 65 are formed in the protuberances 50 distributed along the separation lines X. They consist in holes perpendicular to the diametral plane containing the two separation lines X. The male parts comprise pins 63 inserted in some of these holes, denoted 65, to ensure precise relative positioning of the two internal shells 11.

The protuberances 50 nearest the axial ends of the protective elements 10 are configured to lock the internal shells 11 together and to apply the clamping force urging the protective elements toward one another.

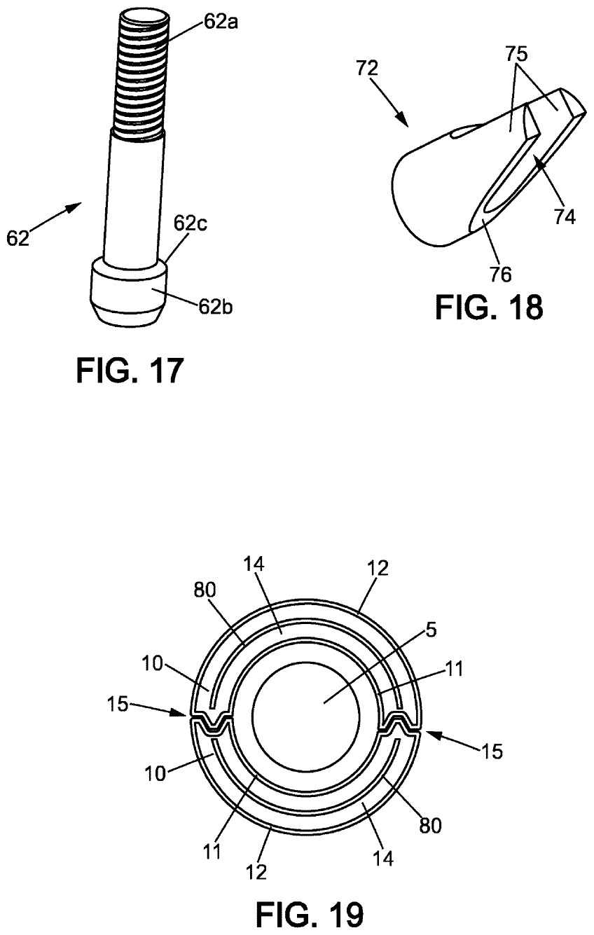

To this end a male part includes a screw 62 represented in perspective in FIG. 17. The screw 62 has a threaded part 62a screwed into threaded holes 67 formed in a protuberance 50 near the axial end of one of the internal shells 11. The other part of the screw 62 forms the male part extending into the interface zone between the protective elements 10 and includes a head 62b that is widened at the level of a shoulder 62c of frustoconical shape. The protuberance 50 formed on the facing internal shell 11 includes the female part in the form of a cylindrical hole 64 (FIG. 16) of sufficient diameter to receive the widened head 62b of the screw 62 during assembly of the elements and a housing 70 extending perpendicularly to the hole 64 and opening onto the end face of the protective element 10. A locking member 72 is driven from the end face into the housing 70 and thus completes the assembly of the protective element 10.

The locking member 72a has for example the wedge shape represented in FIG. 18. It has an exterior profile of complementary shape to the interior profile of the housing 70, for example a cylindrical shape. Its part that penetrates into the housing 70 includes a notch 74 between two wings 75 that pass on respective opposite sides of the screw 62 in the area where the housing 71 crosses the hole 70. The wings 75 have an inclined face 76 forming a ramp that comes to bear on the frustoconical shoulder 62c formed on the screw 62 when the locking member 72 is pushed into its housing 71 from the end face of the shield segment.

To exert the clamping force on the protective elements 10 the installer pushes the locking members 72 into their housings 70. The clamping force results from the interaction of the inclined faces 76 and the frustoconical shoulders 62c. There may be four locking members 72 for each shield segment, namely two locking members at each axial end, inserted in housings 70 that are part of respective protuberances provided in the two internal shells 11.

Note that in the fourth embodiment of the shield represented in FIG. 15 the internal shells 11 have the same geometric shape. The same preferably applies to all of the protective elements 10 of which these internal shells 11 form part.

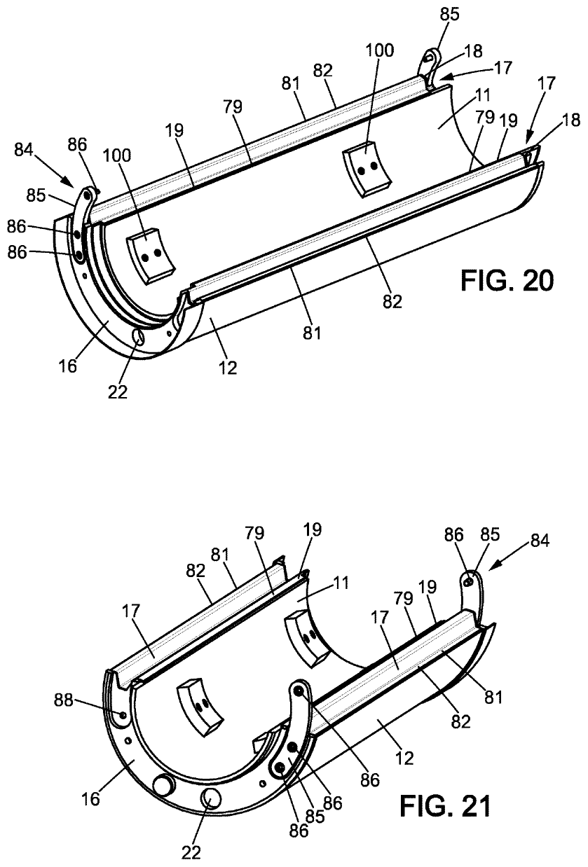

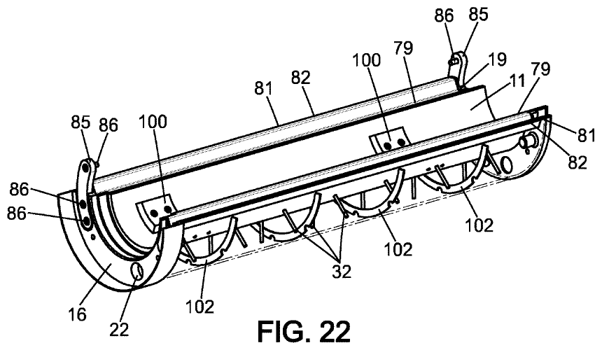

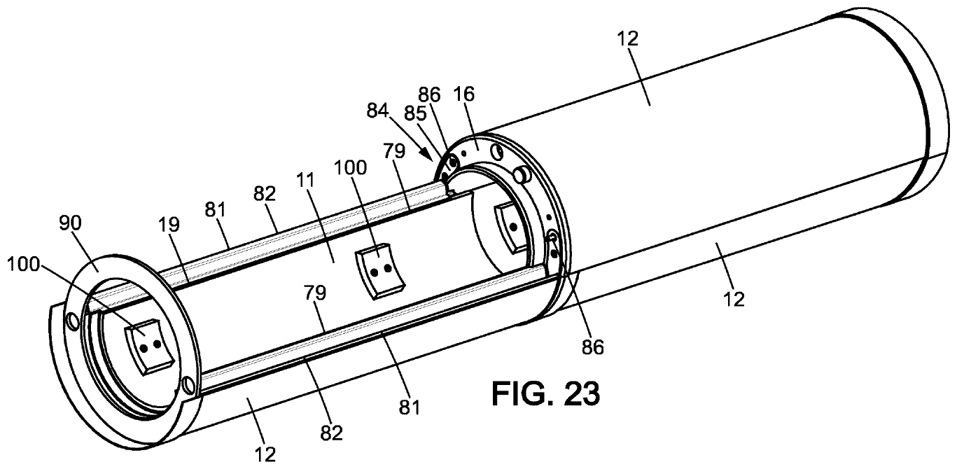

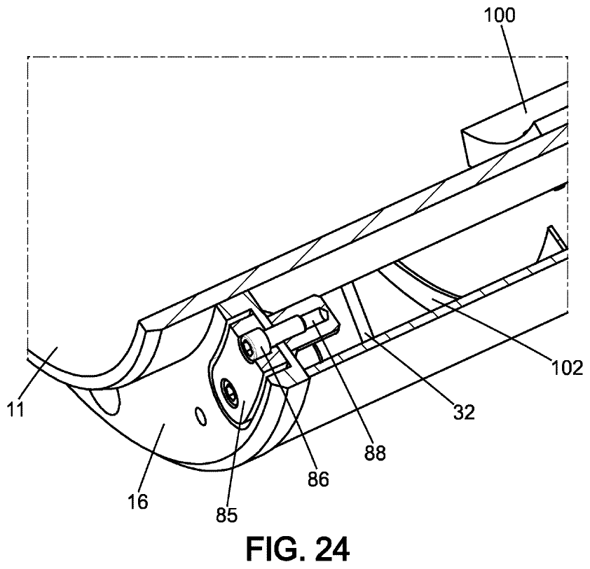

FIGS. 20 to 24 show a fifth embodiment of the shield somewhat similar to the first embodiment. In contrast to the first embodiment the system for assembling the two protective elements 10 has no bayonet couplings between their internal shells 11.

For each shield at least one of the profiled members 17 is covered over its portion 19 bent inward to be connected to the internal shell 11 by an intumescent first longitudinal seal 79. The first seal 79 is in particular based on graphite. The first seal 79 is situated between the two internal shells 11 when the protective shield is installed on a cable 5. In the event of fire the first seal 79 inflates and forms a microporous layer preventing the passage of flames, smoke and hot gases to the interior of the protective shield. The first seal 79 is preferably not compressed during installation of the protective elements 10 in contact with one another. In particular the first seal 79 is applied to the two profiled members 17 of only one of the two protective elements 10.

Each profiled member 17 is further covered over a longitudinal portion 81 to be connected to the external shell 12 by a second longitudinal seal 82 made of elastomer material. The elastomer material is for example ethylene-propylene-diene monomer (EPDM) having a Shore 00 hardness between 40 and 55 inclusive. The second seal 82 is preferably compressed during installation of the protective elements 10 in contact with one another by preloading the protective elements 10. The second seal 82 provides permanent protection against dust. In particular the second seal 82 is applied onto the two profiled members 17 of only one of the two protective elements 10 before assembling the two protective elements 10. The first seal 79 and the second seal 82 are preferably applied to the two profiled members 17 of only one of the two protective elements 10 before assembling the two protective elements 10.

To exert the clamping force on the protective elements 10 when they are installed one in contact with the other the installer can fit temporary rings or belts around the protective elements 10, thus preloading the second seal 82.

At each axial end of a segment in the embodiments from FIGS. 20 to 24 the two axial end faces 16 of each second steel component are held in contact with one another by a locking system 84. The locking system 84 comprises for example two fishplates 85 in the form of a portion of a ring. In particular each fishplate 85 is fixed by bolts 86 screwed axially into threaded orifices 88 provided for this purpose in the axial end faces 16. This method of fixing enables the clamping force or pre-loading between the two protective elements 10 to be maintained when the temporary clamping members are released. In particular, when two protective elements 10 of a segment are assembled together the two fishplates 85 situated at one axial end of the segment are diametrally opposite. The two protective elements 10 of a segment are clamped together with sufficient force to prevent this resulting in friction between the clamped surfaces in the interface zones 15 preventing them from sliding laterally on one another. This mechanism durably maintains the clamping force urging the protective elements toward one another in the two interface zones 15.

An annular third seal 90 is advantageously disposed between shield segments to provide a seal between the segments as well as resistance to aggression and to temperatures between −55° C. and +150° C. inclusive in the junction zones between the segments.

The third seal 90 is in particular made of elastomer material, for example EPDM, having a Shore A hardness between 65 and 75 inclusive.

Shims 100 may be mounted on the interior of the internal shell 11. These shims 100 hold the wire stay rope 5 in the axial passage 8. The shims 100 may be made of high-density polyethylene (PEHD). In particular each protective element 10 includes four shims 100 situated in pairs near each longitudinal end of the protective element 10.

Before fixing the two shield components together it may be judicious to dispose semi-annular spacers 102 between the two shells 11, 12 in addition to or in place of the spacing elements 32 in the form of rods. These spacers 102 are fixed to the inside of the external shell 12. They will participate in increasing the cohesion and the robustness of the shield in the event of an explosion near the wire stay rope.

The embodiments described hereinabove merely illustrate the present invention. Diverse modifications may be made to them without departing from the scope of the invention defined by the appended claims.

For example FIG. 19 depicts a modification wherein the filling 14 present in the radial gap between the internal shell 11 and the external shell 12 of a protective element 10 includes in addition to the cement material one or more metal bands buried in the cement material.

A band 80 of this type further strengthens the cohesion and the ductility of the shield in the event of a powerful impact or a shockwave on the external wall 12. It may consist in a metal plate formed to shape and disposed parallel to the second shells 11, 12. If necessary this plate 80 is provided with orifices to allow the spacing rods 32 described above to pass through it. A perforated structure of the metal band 80, for example a grid, honeycomb or expanded metal structure, facilitates its integration with the cement material and improves the mechanical behavior of the shield in the presence of a threat. To optimize the reinforcement produced by the bands 80 they may be arranged so that they extend over virtually all the length of the shells 11, 12.

1-33. (canceled)

34. A structural cable comprising:
a tensioning member; and
a protective shield disposed around the tensioning member, wherein the protective shield comprises:
two protective elements extending parallel to the tensioning member; and
a system for assembling the two protective elements around an axial passage for the tensioning member;
wherein each of the two protective elements includes a first shell adjacent to the axial passage, a second shell, and a filling in a radial gap between the first and second shells; and
wherein the system for assembling the two protective elements is configured to exert a clamping force on the two protective elements urging one of the two protective elements toward the other of the two protective elements, in two interface zones between the two protective elements.

35. The structural cable as claimed in claim 34,
wherein the radial gap between the first and second shells of one of the two protective elements is maintained by rods engaged radially through the first shell from the axial passage and bearing against an internal face of the second shell.

36. The structural cable as claimed in claim 34,
wherein the second shell of a protective element is fixed to the first shell by connecting members engaged through the first shell from the axial passage.

37. The structural cable as claimed in claim 34,
wherein the two interface zones between the protective elements are diametrically opposite relative to the axial passage.

38. The structural cable as claimed in claim 37,
wherein the two protective elements have a same geometric shape.

39. The structural cable as claimed in claim 34,
wherein a water drainage channel is formed in each interface zone between the two protective elements.

40. The structural cable as claimed in claim 34,
wherein in each interface zone between the two protective elements, one of the two protective elements has at least one convex shape and the other of the two protective elements has at least one conjugate shape conjugate to the convex shape.

41. The structural cable as claimed in claim 40,
wherein respective convex and concave shapes of the two protective elements extend over all of a length of the protective elements.

42. The structural cable as claimed in claim 41,
wherein a water drainage channel is formed at a bottom of the concave shape in each interface zone between the two protective elements.

43. The structural cable as claimed in claim 34,
wherein separation lines between the respective first shells of the two protective elements extend parallel to the axial passage and feature an angular offset relative to the two interface zones between the protective elements.

44. The structural cable as claimed in claim 34,
wherein the system for assembling the protective elements comprises a bayonet coupling formed between the first shells of the two protective elements; and
wherein the bayonet coupling includes a ramp inclined relative to an axial direction and cooperating with a locking member to exert the clamping force urging the protective elements toward one another.

45. The structural cable as claimed in claim 44,
wherein the bayonet coupling is configured to allow axial sliding between the first shells of the two protective elements to assemble the protective elements.

46. The structural cable as claimed in claim 44,
wherein the locking member comprises a slider disposed at a level of the axial passage and able to be moved parallel to the axial passage; and
wherein the slider includes a locking pin cooperating with the inclined ramp of the bayonet coupling.

47. The structural cable as claimed in claim 34,
wherein the system for assembling the protective elements comprises male parts and female parts provided in the protective elements at a level of the interface zones and locking members,
wherein the male parts penetrate into the female parts to mutually position the two protective elements, and
wherein the locking members cooperate with at least some of the male parts to exert the clamping force urging the protective elements toward one another.

48. The structural cable as claimed in claim 47,
wherein the locking member has an inclined surface to interact with a shoulder formed on a male part of the system for assembling the protective elements.

49. The structural cable as claimed in claim 47,
wherein the locking members are controllable from axial ends of the protective elements.

50. The structural cable as claimed in claim 49,
wherein each locking member is configured to be pushed from an axial end of a protective element into a respective housing to cooperate with a male part of the system for assembling the protective elements.

51. The structural cable as claimed in claim 47,
wherein the male parts of the assembly system comprise positioning pins distributed along the protective elements.

52. The structural cable as claimed in claim 34,
wherein the system for assembling the protective elements is formed on protuberances on the first shells protruding toward the interior of the axial passage.

53. The structural cable as claimed in claim 34,
wherein the filling in the radial gap between the first and second shells of each protective element comprises a cement material and at least one metal band in the cement material.

54. The structural cable as claimed in claim 53,
wherein the metal band is disposed substantially parallel to the first and second shells.

55. The structural cable as claimed in claim 53,
wherein the metal band extends over a majority of a length of the first and second shells from one interface zone to the other.

56. The structural cable as claimed in claim 53,
wherein the metal band has a perforated structure.

57. The structural cable as claimed in claim 34,
wherein the filling in the radial gap between the first and second shells of each protective element comprises an auxetic material.

58. The structural cable as claimed in claim 34, further comprising an intumescent first longitudinal seal in at least one interface zone between the protective elements.

59. The structural cable as claimed in claim 34, further comprising a second longitudinal seal in at least one interface zone between the protective elements, the second seal being made of elastomer and configured to be compressed during assembly of the protective elements toward one another.

60. A structural cable comprising
a tensioning member; and
a plurality of segments of a protective shield disposed around the tensioning member, wherein each segment of the plurality of segments comprises:
two protective elements extending parallel to the tensioning member; and
a system for assembling the two protective elements around an axial passage for the tensioning member;
wherein each of the two protective elements includes a first shell adjacent to the axial passage, a second shell and a filling in a radial gap between the first and second shells, and wherein the system for assembling the two protective elements is configured to exert a clamping force on the two protective elements urging one of the two protective elements toward the other of the two protective elements, in two interface zones between the two protective elements; and
wherein an interface is provided between two successive segments of the plurality of segments, wherein at the interface, respective end faces of the two protective elements of the two successive segments bear on one another.

61. The structural cable as claimed in claim 60,
wherein end faces of the protective elements at the interface between the successive segments are provided with reliefs configured to prevent relative rotation of the segments about the axial passage.

62. The structural cable as claimed in claim 60,
wherein at the interface between a first segment and a second segment the first shells of the protective elements of the first segment extend beyond axial ends of the second shells of the protective elements of the first segment, parallel to the axial passage, wherein the first shells of the protective elements of the second segment are set back from the axial ends of the second shells of the protective elements of the second segment, parallel to the axial passage; and
wherein the axial ends of the first shells of the protective elements of the first segment penetrate to the interior of the second shells of the protective elements of the second segment.

63. The structural cable as claimed in claim 60,
wherein at the interface between the successive segments the first shells of the protective elements have a spacing between the successive segments parallel to the axial passage.

64. The structural cable as claimed in claim 60,
wherein the interface zones between the two protective elements of a first segment are angularly offset relative to the interface zones between the two protective elements of a second segment adjacent to the first segment.

65. The structural cable as claimed in claim 60, wherein the system for assembling the protective elements comprises fishplates at a level of the end faces of a segment to maintain the clamping force urging the protective elements toward one another.

66. A construction work comprising the structural cable as claimed in claim 34, the tensioning member of the structural cable being tensioned and anchored at two ends.
